(19) United States
(12) Patent Application Publication
(10) Pub. No.: US 2023/0352779 A1
(43) Pub. Date: Nov. 2, 2023

(54) POWER STORAGE DEVICE AND PRODUCING METHOD THEREFOR

(71) Applicant: Prime Planet Energy & Solutions, Inc., Tokyo (JP)

(72) Inventors: Atsushi MIYAZAKI, Himeji-shi (JP); Shingo YAMANE, Nagakute-shi (JP); Kohji UMEMURA, Ono-shi (JP)

(21) Appl. No.: 18/173,792

(22) Filed: Feb. 24, 2023

(30) Foreign Application Priority Data
Mar. 31, 2022 (JP) 2022-057842

(51) Int. Cl. H01M 50/169; H01M 10/34; H01M 50/186

(52) U.S. Cl. CPC H01M 50/169; H01M 10/34; H01M 50/186; H01M 2220/20

(57) ABSTRACT

A power storage device includes a lid of a case housing an electrode body and a stopper welded to a liquid inlet circumferential portion of the lid by energy-beam welding to seal the liquid inlet. An annular solidified molten portion made of metal, which has been once molten and then solidified, is positioned on a lid thickwise inside than a lid outer plane of the lid over the entire circumference, and has a surface which continues to an outer annular step surface and a peripheral outward surface and fomes a convex shape toward a lid thickwise outside.

### CROSS-REFERENCE TO RELATED APPLICATIONS

This application is based upon and claims the benefit of priority from the prior Japanese Patent Application No. 2022-057842, filed Mar. 31, 2022, the entire contents of which are incorporated herein by reference.

### BACKGROUND

### Technical Field

The present disclosure relates to a power storage device and a producing method for a power storage device.

### Related Art

Heretofore, there has been known a hermetically-sealed power storage device such as a hermetically-sealed battery in which an electrode body and electrolytic solution are housed in a case body sealed its opening with a lid and a positive electrode terminal and a negative electrode terminal penetrate through the lid and extend outside (see JP2013-105678A).

In this type of a power storage device, an electrode body is housed in a case body and an opening is sealed by a lid, and then electrolytic solution is injected in the case through a liquid inlet provided in advance in the lid. Thereafter, this liquid inlet is sealed by laser welding an outer peripheral edge portion of a stopper with a liquid inlet circumferential portion of the lid.

### SUMMARY

### Technical Problems

However, when the outer peripheral edge portion of the stopper is to be laser-welded with the liquid inlet circumferential portion of the lid, spatters (molten metal droplets) could scatter from welded parts and adhere to various parts of the lid. Especially, adhesion of the spatters on surfaces of a positive electrode insulator and a negative electrode insulator, which are to insulate the lid from a positive electrode terminal and a negative electrode terminal both penetrating and extending outside the lid, is unpreferable since there is a high possibility of degrading the insulation characteristics between a positive electrode or a negative electrode and a casing. Especially in a case that the spatters scatter from the welded parts at a low angle to impinge on or collide with and adhere to the insulators by a short flying distance, it is further unpreferable as compared to a case that the spatters scatter with forming a shape of an arch with a relatively long flying distance. Due to such a short flying distance, the spatters (metal droplets) in a molten state hit and adhere to the insulators made of resin in a molten state, so that the spatters tend to get deeply into the insulators and thus to be difficult to fall off.

On the other hand, when a contact step portion formed around a periphery of the liquid inlet of the lid to bring a contact surface of the stopper into contact therewith is recessed and an outer step portion surrounding this contact step portion is provided to arrange the stopper on a radial inside of this outer step portion so that the outer step portion of the lid and the outer peripheral edge portion of the stopper are to be laser welded, there needs to arrange a radial dimension of the outer peripheral edge portion of the stopper smaller than a radial dimension of the outer step portion of the lid. This however results in generation of a clearance between the outer step portion of the lid and the outer peripheral edge portion of the stopper. Furthermore, a size of this clearance cannot be necessarily made uniform in a circumferential direction, so that there might be generated a thin part in a solidified molten portion made of metal formed by laser welding, which has once been molten and then solidified. This could lead to degradation in the sealing performance of the stopper.

The present disclosure has been made in view of the above circumstance and has a purpose of providing a power storage device having preferable insulation characteristics with restraining adhesion of spatters on a positive electrode insulator and a negative electrode insulator and being provided with a stopper welded to a liquid inlet circumferential portion of a lid with preferable sealing characteristics and a producing method of this power storage device.

### Means of Solving the Problems

One aspect of the present disclosure to solve the above problem is A power storage device comprising: an electrode body; a case body having an opening and housing the electrode body therein; a lid of a flat-plate-like shape sealing the opening and having a liquid inlet penetrating therethrough in a lid thickwise direction; a positive electrode terminal and a negative electrode terminal conducting with the electrode body and penetrating through the lid to extend outside; a positive electrode insulator insulating the lid and the positive electrode terminal; a negative electrode insulator insulating the lid and the negative electrode terminal; and a stopper welded by energy beam to a liquid inlet circumferential portion surrounding the liquid inlet of the lid to seal the liquid inlet, wherein the liquid inlet circumferential portion of the lid includes: a contact step portion of an annular shape including a lid contact surface of an annular shape and surrounding the liquid inlet; and an outer step portion of an annular shape including an outer annular step surface of an annular flat shape and surrounding the contact step portion, the lid contact surface is configured to be positioned on a lid thickwise inside than a lid outer plane of the lid and face toward a lid thickwise outside, the outer annular step surface is configured to be positioned on a hole radial outside than the lid contact surface, on the lid thickwise inside than the lid outer plane and on the lid thickwise outside than the lid contact surface, and face toward the lid thickwise outside, the stopper is configured to: be positioned on a hole radial inside than the outer step portion; include a stopper contact surface of an annular shape facing toward the lid thickwise inside to oppose and be contacted with the lid contact surface, and a peripheral outward surface of a flat shape facing toward the lid thickwise outside, have an outer peripheral edge portion of an annular shape contacted with the contact step portion, a solidified molten portion of an annular shape made of metal, which is once molten and then solidified, is formed between the outer step portion of the lid and the outer peripheral edge portion of the stopper, the solidified molten portion is configured to be positioned its entire circumference on the lid thickwise inside than the lid outer plane of the lid, a surface of the solidified molten portion in its entire circumference is configured to: continue to the outer annular step surface and the peripheral outward surface; and form a convex shape toward the lid thickwise outside.

In this power storage device, the solidified molten portion is positioned on the lid thickwise inside than the outer plane of the lid. Therefore, even if the spatters are generated when the solidified molten portion is formed by energy beam welding, the spatters flying at a low angle impinge on a step surface between the lid outer plane and an outer step portion of the lid on the lid thickwise outside than the solidified molten portion, so that the spatters are prevented from flying outside the liquid inlet circumferential portion. Accordingly, the spatters in a molten state flying from the solidified molten portion at a low angle can be restrained from adhering by hitting on and deeply getting into the positive electrode insulator and the negative electrode insulator.

On the other hand, in this power storage device, a surface of the solidified molten portion continues to the outer annular step surface of the outer step portion of the lid and the peripheral outward surface of the stopper, and also, the surface is of a convex shape toward the lid thickwise outside. Therefore, there is no portion in which the molten metal constituting the solidified molten portion is locally reduced, and thus the solidified molten portion has no local portion that has small dimension in the lid thickwise direction and gets degraded its sealing performance.

Accordingly, the power storage device can achieve preferable insulation characteristics of restraining adhesion of spatters on the positive electrode insulator and the negative electrode insulator and preferable sealing characteristics of welding the stopper to the liquid inlet circumferential portion of the lid.

As the power storage device, a secondary battery such as a lithium-ion secondary battery and a capacitor such as a lithium-ion capacitor may be exemplified.

Further, as energy beam welding, laser welding using laser beam and electron-beam welding using electron beam may be exemplified.

In the liquid inlet circumferential portion of the lid, an entire inner circumferential surface of the contact step portion may constitute a liquid inlet, and alternatively, a step portion protruding on the hole radial inside may further be provided on the hole radial inside of the contact step portion. Further, the hole radial outside of the outer step portion may continue to the outer plane, and there may be provided an annular groove positioned on the lid thickwise inside than the outer plane of the lid on the hole radial outside of the outer step portion with keeping a clearance from the outer step portion.

(2) In the power storage device according to the above (1), preferably, a shorter one of a positive electrode shortest distance between the positive electrode insulator and the solidified molten portion and a negative electrode shortest distance between the negative electrode insulator and the solidified molten portion is equal to or less than 30 mm.

In the above-mentioned power storage device, the shortest distance between the solidified molten portion and the positive electrode insulator or the negative electrode insulator is as short as 30 mm or less. Therefore, the effect of restraining adhesion of the spatters on the positive electrode insulator and the negative electrode insulator by the above configuration is highly expected, and thus, the insulation characteristics of the power storage device can be maintained preferably.

Another aspect of the present disclosure to solve the above problem is a producing method of a power storage device comprising: an electrode body; a case body having an opening and housing the electrode body therein; a lid of a flat-plate-like shape sealing the opening and having a liquid inlet penetrating therethrough in a lid thickwise direction; a positive electrode terminal and a negative electrode terminal conducting with the electrode body and penetrating through the lid to extend outside; a positive electrode insulator insulating the lid and the positive electrode terminal; a negative electrode insulator insulating the lid and the negative electrode terminal; and a stopper welded by energy beam to a liquid inlet circumferential portion surrounding the liquid inlet of the lid to seal the liquid inlet, wherein the liquid inlet circumferential portion of the lid includes: a contact step portion of an annular shape including a lid contact surface of an annular shape and surrounding the liquid inlet; and an outer step portion of an annular shape including an outer annular step surface of an annular flat shape and surrounding the contact step portion, the lid contact surface is configured to be positioned on a lid thickwise inside than a lid outer plane of the lid and face toward a lid thickwise outside, the outer annular step surface is configured to be positioned on a hole radial outside than the lid contact surface, on the lid thickwise inside than the lid outer plane and on the lid thickwise outside than the lid contact surface, and face toward the lid thickwise outside, the stopper is configured to: be positioned on a hole radial inside than the outer step portion; include a stopper contact surface of an annular shape facing toward the lid thickwise inside to oppose and be contacted with the lid contact surface, and a peripheral outward surface of a flat shape facing toward the lid thickwise outside, have an outer peripheral edge portion of an annular shape contacted with the contact step portion, a solidified molten portion of an annular shape made of metal, which is once molten and then solidified, is formed between the outer step portion of the lid and the outer peripheral edge portion of the stopper, the solidified molten portion is configured to be positioned its entire circumference on the lid thickwise inside than the lid outer plane of the lid, a surface of the solidified molten portion in its entire circumference is configured to: continue to the outer annular step surface and the peripheral outward surface; and form a convex shape toward the lid thickwise outside, wherein the outer step portion of the lid before welding and the outer peripheral edge portion of the stopper before welding include a to-be-molten protruding portion as at least any one of: a to-be-molten outer protruding portion positioned on the hole radial inside than the outer annular step surface of the lid and protruding on the lid thickwise outside than the outer annular step surface; and a to-be-molten stopper outer circumferential protruding portion positioned on the stopper radial outside than the peripheral outward surface of the stopper and protruding on the stopper thickwise outside than the peripheral outward surface, the method includes: stopper arranging to arrange the stopper on the hole radial inside than the outer step portion of the lid in a state in which the stopper contact surface of the stopper opposes and comes to contact with the lid contact surface of the lid; and stopper welding to weld the outer step portion of the lid and the outer peripheral edge portion of the stopper over an entire circumference by energy beam, and the stopper welding is to perform welding by melting the to-be-molten protruding portion.

In this producing method, the lid or the stopper before welding includes the to-be-molten protruding portion (at least any one of the to-be-molten outer protruding portion provided in the outer step portion of the lid before welding and the to-be-molten stopper outer circumferential protruding portion provided in the outer peripheral edge portion of the stopper), and welding in the stopper welding is performed by melting the to-be-molten protruding portion. Therefore, molten metal of a molten part of the to-be molten protruding portion can also be used for formation of the solidified molten portion. As a result of this, the solidified molten portion continuing to the outer annular step surface and the peripheral outward surface to form a convex shape toward the lid thickwise outside can be easily formed over the entire circumference.

Furthermore, the spatters flying from a portion to be the solidified molten portion at a low angle impinge on a step surface or the like between the lid outer plane and the outer step portion of the lid which are located on the lid thickwise outside than the solidified molten portion, so that the spatters can be prevented from flying out of the liquid inlet circumferential portion. Accordingly, the spatters flying from the solidified molten portion at a low angle in the molten state can also be restrained from adhering by impinging and deeply getting into the positive electrode insulator and the negative electrode insulator.

As mentioned above, the power storage device can achieve preferable insulation characteristics by restraining adhesion of the spatters to the positive electrode insulator and the negative electrode insulator and achieve preferable sealing characteristics of welding the stopper to the liquid inlet circumferential portion of the lid.

A configuration of the to-be-molten protruding portion (the to-be-molten outer protruding portion and the to-be-molten stopper outer circumferential protruding portion) may be of an annular shape continuing over a circumference in the circumferential direction of the liquid inlet or in the circumferential direction of the stopper. Alternatively, the configuration may be a shape of an annular broken line in which parts provided with the to-be-molten protruding portion and parts not-provided with the to-be-molten protruding portion are alternately formed.

Further, the to-be-molten protruding portion may be of a rectangular shape in its radial section with a flat top surface, and as one alternative, the to-be-molten portion may be of a semi-circular shape in section.

(4) The producing method of the power storage device according to the above (3), preferably, the to-be-molten protruding portion is of an annular shape over its circumference, and the to-be-molten protruding portion includes a sectional shape large enough to remain surplus molten metal even when a clearance between the outer peripheral edge portion of the stopper before welding and the outer step portion of the lid before welding becomes the maximum clearance, which is the largest clearance formed therebetween, is filled with the molten metal of the to-be-molten protruding portion.

In this producing method, the sectional shape of the to-be-molten protruding portion is arranged such that, even when the maximum clearance between the outer peripheral edge portion of the stopper and the outer step portion of the lid before welding is filled with the molten metal of the to-be-molten protruding portion that has been molten, the molten metal exceeds the radial sectional area of the maximum clearance. Accordingly, the surface of the solidified molten portion is of the convex shape over the entire circumference, and thus the power storage device with no partially thin part created in the solidified molten portion can be assuredly produced.

(5) The producing method of the power storage device according to the above (3) or (4), preferably, the lid before welding includes the to-be-molten outer protruding portion on the hole radial inside of the outer annular step surface, the stopper before welding includes no to-be-molten stopper outer circumferential protruding portion on the outer peripheral edge portion, and the outer annular step surface of the lid is positioned on the lid thickwise inside than the peripheral outward surface of the stopper.

In this producing method, while the lid before welding includes the to-be-molten outer protruding portion, the stopper before welding does not include the to-be-molten stopper outer circumferential protruding portion, and the outer annular step surface of the lid after welding is positioned on the lid thickwise inside than the peripheral outward surface of the stopper. Namely, the outer annular step surface of the annular outer step portion of the lid is positioned on the lid thickwise inside than the peripheral outward surface of the stopper to have thin thickness.

Accordingly, in the stopper welding, the heat of the irradiated energy beam is restrained from escaping through the outer step portion toward the hole radial outside of the liquid inlet circumferential portion, so that the to-be-molten outer protruding portion and others can be appropriately molten.

(6) Further, the producing method of the power storage device according to any one of the above (3) to (5), preferably, the lid before welding includes the to-be-molten outer protruding portion on the hole radial inside of the outer annular step surface, the stoper before welding includes no to-be-molten stopper outer circumferential protruding portion on the outer peripheral edge portion but includes an extended peripheral outward surface extending to the stopper radial outside from the peripheral outward surface and a stopper outer circumferential end face extending to the stopper thickwise inside from an outer peripheral edge of the extended peripheral outward surface and facing the stopper radial outside, and a height from the lid contact surface to an outer protruding portion top face of the to-be-molten outer protruding portion is as 1.1 to 1.4 times large as a thickness from the stopper contact face to the extended peripheral outward surface of the stopper.

In the stopper welding (welding of the stopper), it is preferable that the outer step portion of the lid and the outer peripheral edge portion of the stopper are molten by the energy beam so that a leading end of the formed solidified molten portion (an inner end on the lid thickwise inside) is positioned at the almost same level with the lid contact surface. While too shallow molten level leads to low welding strength, too deep molten level leads to melting of the lid over the whole lid thickwise direction, both of which are unpreferable.

On the other hand, there is a case that the height from the lid contact surface to the outer protruding-portion top face of the to-be-molten outer protruding portion of the lid, which is hereinafter referred as the height H1, is too large as compared to a thickness of the outer peripheral edge portion, i.e., the thickness from the stopper contact surface to the extended peripheral outward surface, which is hereinafter referred as the thickness T1. In other words, there is a case that the difference between the height H1 and the thickness T1 is large. In this case, a difference could be easily generated in the molten state of the outer step portion having the to-be-molten outer protruding portion of the lid and the outer peripheral edge portion of the stopper by irradiation of the energy beam from the lid thickwise outside. Specifically, a vicinity of the stopper outer-peripheral end face of the outer peripheral edge portion of the stopper is molten over the whole stopper thickwise direction. However, a portion on the lid thickwise inside than the to-be-molten outer protruding portion of the outer step portion of the lid fails to be molten deeply enough, resulting in distortion in a shape of the solidified molten portion, so that the welding between the outer step portion of the lid and the outer peripheral edge portion of the stopper could be made incompletely.

When the height H1 is not very large as compared to the thickness T1, an amount of the molten metal formed by melting the to-be-molten outer protruding portion becomes less, so that a filling amount of the molten metal to be filled in a clearance between the outer step portion of the lid and the outer peripheral edge portion of the stopper might fall short.

To address this, as mentioned above, in the producing method, the height H1 from the lid contact surface to the outer protruding-portion top face of the to-be-molten outer protruding portion is made as 1.1 to 1.4 times large as the thickness T1 from the stopper contact surface of the stopper to the extended peripheral outward surface, which can be represented as H1=1.1 × T1 to 1.4 × T1. Thus, by melting the to-be-molten outer protruding portion in the stopper welding, the molten metal (molten metal body) to be the solidified molten portion is obtained to provide the solidified molten portion in a preferable figure, so that a power storage device in which the outer step portion of the lid and the outer peripheral edge portion of the stopper are welded can be produced.

The producing method for the power storage device according to the above (3) or (4), preferably, the stopper before welding includes the to-be-molten stopper outer circumferential protruding portion on the outer peripheral edge portion, the lid before welding includes no to-be-molten outer protruding portion on the hole radial inside of the outer annular step surface but includes an extended outer annular step surface extending to the hole radial inside from the outer annular step surface and an inner step surface extending to the lid thickwise inside from an inner peripheral edge of the extended outer annular step surface to reach the lid contact surface and facing the hole radial inside, and a thickness from the stopper contact surface to a stopper protruding-portion top face of the to-be-molten stopper outer circumferential protruding portion is as 1.1 to 1.4 times large as a height from the lid contact face to the extended outer annular step surface.

As mentioned above, in the stopper welding (welding of the stopper), it is preferable to melt the outer step portion of the lid and the outer peripheral edge portion of the stopper by the energy beam so that the leading end of the solidified molten portion formed by melting is positioned at the almost same level with the lid contact surface.

On the other hand, there is a case that the thickness from the stopper contact surface to the stopper protruding-portion top face of the to-be-molten stopper outer circumferential protruding portion, which is hereinafter referred as the thickness T2, is made too large as compared to the height of the outer step portion (having no to-be-molten outer protruding portion) of the lid, namely, the height from the lid-side contract surface to the extended outer annular surface, which is hereinafter referred as the height H2. In other words, there is a case that a difference in the thickness T2 and the height H2 is large. In this case, irradiation of the energy beam to the both from the lid thickwise outside easily causes a difference in the molten state of the outer step portion of the lid and the outer peripheral edge portion of the stopper. To be specific, the outer step portion of the liquid inlet circumferential portion of the lid gets deeply molten. However, a portion on the stopper thickwise inside than the to-be-molten stopper outer circumferential protruding portion of the outer step portion of the stopper fails to be molten deeply enough, so that a vicinity of the stopper outer-peripheral end face fails to be molten enough in the entire height direction (especially in its inside portion), resulting in distortion in a shape of the solidified molten portion. This would cause incomplete welding of the outer step potion of the liquid inlet circumferential portion of the lid and the outer peripheral edge portion of the stopper.

On the other hand, when the thickness T2 is not very large as compared to the height H2, an amount of the molten metal formed by melting the to-be-molten stopper outer circumferential protruding portion becomes less, and thus a filling amount of the molten metal to be filled in the clearance between the outer step portion of the lid and the outer peripheral edge portion of the stopper could fall short.

To address this, in this producing method mentioned above, the thickness T2 from the stopper contact surface of the stopper to the stopper protruding-portion top face of the to-be-molten stopper outer circumferential protruding portion is made to be as 1.1 to 1.4 times large as the height H2 from the lid contact surface to the extended outer annular step surface of the lid, which can be represented as T2=1.1 × H2 to 1.4 × H2. Accordingly, melting the to-be-molten stopper outer circumferential protruding portion achieves obtention of the molten metal (molten metal body) to be the solidified molten portion and preferable formation of the solidified molten portion, so that the power storage device in which the outer step portion of the lid and the outer peripheral edge portion of the stopper are welded can be produced.

(8) The producing method of the power storage device according to the above (3) or (4), preferably, the lid before welding includes the to-be-molten outer protruding portion on the hole radial inside of the outer annular step surface, and the stopper before welding includes the to-be-molten stopper outer circumferential protruding portion on the outer peripheral edge portion.

In this producing method, both the to-be-molten outer protruding portion and the to-be-molten stopper outer circumferential protruding portion as the to-be-molten protruding portion are molten to obtain the molten metal (molten metal body) which is to become the solidified motel portion. Owing to this, even when a size of the clearance between the outer peripheral edge portion of the stopper and the outer step portion of the liquid inlet circumferential portion of the lid varies in the circumferential direction, the thickness of the solidified motel portion can be assuredly obtained, and thus the power storage device in which the outer peripheral edge portion and the outer step portion are preferably welded can be produced.

### BRIEF DESCRIPTION OF THE DRAWINGS

FIG. 1 is a perspective view of a battery in an embodiment and modified embodiments 1 and 2;

FIG. 2 is a flowchart indicating each step for producing the battery in the embodiment and the modified embodiments 1 and 2;

FIG. 3 is a partial enlarged sectional view showing a state in which a stopper is placed on a lid of the battery in the embodiment;

FIG. 4 is a sectional explanatory view indicating a relation of a clearance formed between a lid and the stopper of the battery and a to-be-molten protruding portion in the embodiment;

FIG. 5 is a partial enlarged sectional view showing a state in which the stopper placed on the lid of the battery is laser welded in the embodiment;

FIG. 6 is a partial enlarged sectional view showing a state in which the stopper is placed on the lid of the battery in the modified embodiment 1;

FIG. 7 is a partial enlarged sectional view showing a state in which the stopper placed on the lid of the battery is laser welded in the modified embodiment 1;

FIG. 8 is a partial enlarged sectional view showing a state in which the stopper is placed on the lid of the battery in the modified embodiment 2; and

FIG. 9 is a partial enlarged sectional view showing a state in which the stopper placed on the lid of the battery is laser welded in the modified embodiment 2.

### DETAILED DESCRIPTION OF THE EXEMPLARY EMBODIMENTS

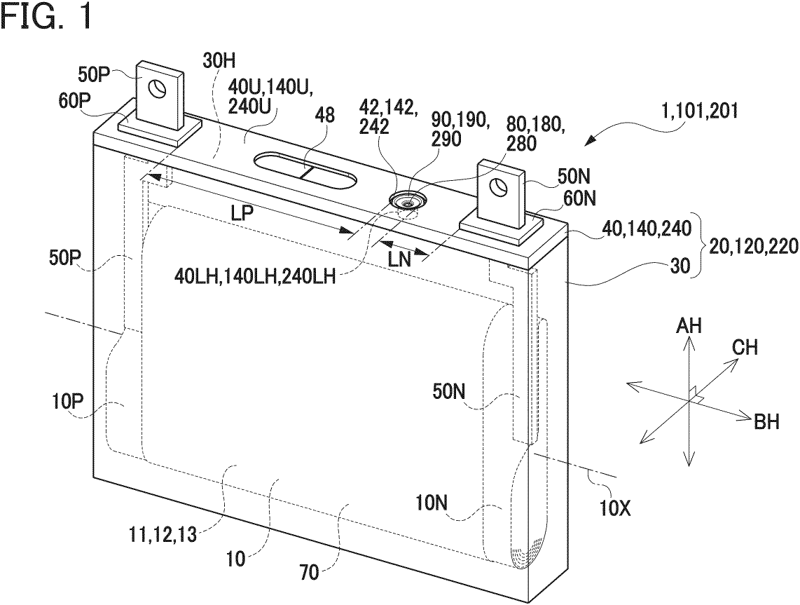

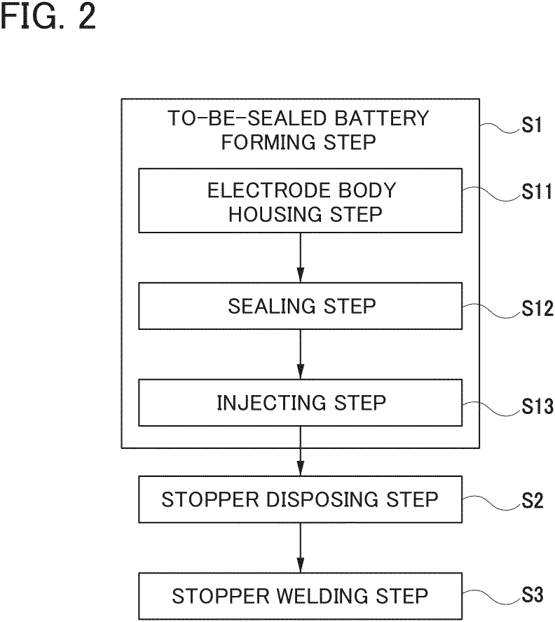

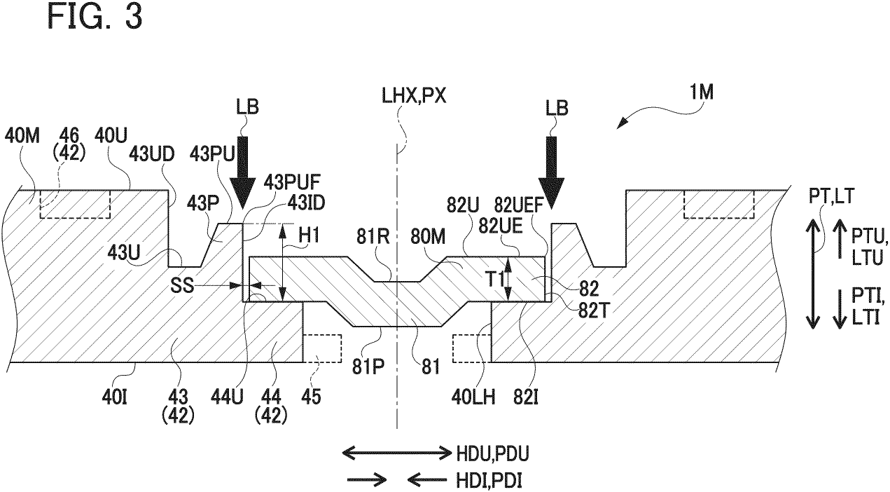

An embodiment of the present disclosure is explained below with reference to the accompanying drawings. FIG. 1 is a perspective view of a battery (power storage device) 1 according to the present embodiment. FIG. 2 is a flowchart illustrating each step. FIGS. 3 to 5 show an enlarged sectional view and an explanatory view illustrating a relation of a lid 40 and a stopper 80 of the battery 1. Herein, the following explanation is to be made with defining a battery height direction AH, a battery widthwise direction BH, and a battery thickwise direction CH of the battery 1 as directions indicated in FIG. 1. This battery 1 is a rectangular hermetically-closed lithium-ion secondary battery mounted on vehicles such as a hybrid car, a plug-in hybrid car, and an electric automobile.

### Embodiment

The battery 1 is configured with a case 20, an electrode body 10 housed inside the case 20, a positive electrode terminal 50P and a negative electrode terminal 50N fixedly provided in the case 20, and others. The electrode body 10 is covered with a not-shown bag-shaped insulation film inside the case 20. Further in the case 20, electrolytic solution 70 is housed in a state that a part of the solution is impregnated in the electrode body 10 and another part remains on a bottom part of the case 20.

The case 20 of those components is made of metal (aluminum in the present embodiment) and is configured with a case body 30 of a bottomed rectangular cylindrical shape having an opening 30H in one end (an upper side in FIG. 1) and a lid 40 of a rectangular plate-like shape welded to the case body 30 to close the opening 30H.

The lid 40 is fixedly provided with a positive electrode terminal 50P made of aluminum material, penetrating the lid 40 and extending outside the case 20 in a vicinity of one end portion (an upper left side in FIG. 1) in the battery width direction BH in a state insulated from the lid 40 through a positive electrode insulator 60P. This positive electrode terminal 50P is connected and continues to a positive current collecting portion 10P of the electrode body 10 in the case 20.

Further, the lid 40 is fixedly provided with a negative electrode terminal 50N made of copper material, penetrating through the lid 40 and extending outside the case 20 in a vicinity of the other end portion (a lower right side in FIG. 1) in the battery width direction BH in a state insulated from the lid 40 through a negative electrode insulator 60N. This negative electrode terminal 50N is connected and continues to a negative current collecting portion 10N of the electrode body 10 in the case 20.

Herein, the positive electrode insulator 60P and the negative electrode insulator 60N are made of insulative resin, and in the present embodiment, specifically made of PFA. As insulative resin material configuring the insulators 60P and 60N, any appropriate insulative resin such as PE, PP, and PPS may be used other than fluororesin such as the above-mentioned PFA.

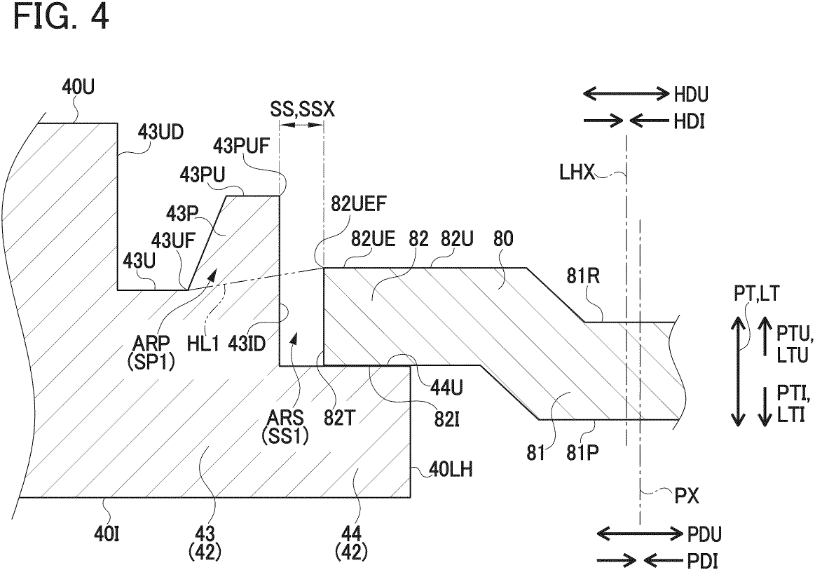

Further, in a vicinity of a center portion of the lid 40 in the battery width direction BH, a safety valve 48 to be broken and open when an inner pressure of the case 20 exceeds a valve-open pressure. In a center portion of a liquid inlet circumferential portion 42 of the lid 40 close to the negative electrode terminal 50N (a right side in FIG. 1), a liquid inlet 40LH (see FIG. 3 and FIG. 4) communicating inside and outside of the case 20 is perforated. This liquid inlet 40LH is used for injecting the electrolytic solution 70 in the case 20.

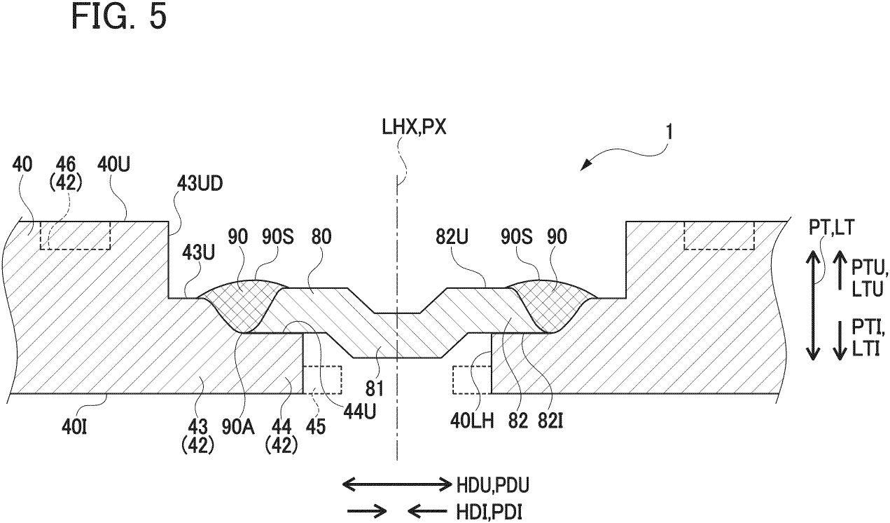

This liquid inlet 40LH is hermetically closed by a disc-like stopper 80 made of metal (in the present embodiment, aluminum). Specifically, the liquid inlet 40LH is covered with the stopper 80 that is placed in the liquid inlet circumferential portion 42 of the lid 40, and then closed by welding the stopper 80 to the liquid inlet circumferential portion 42 of the lid 40 over the entire circumference. In between the lid 40 and the stopper 80, there is provided an annular-shaped solidified molten portion 90 formed by metal which has once been molten and then solidified. As it will be explained later with reference to FIG. 5, this annular solidified molten portion 90 is positioned on a lid thickwise inside LTI (a lower side in FIG. 4) than a lid outer plane 40U of the lid 40 over the entire circumference. Therefore, among the spatters (not shown) generated when the solidified molten portion 90 is to be formed for welding by laser welding, the molten spatters flying at a low angle impinge on the outer step surface 43UD and the like, so that the spatters are prevented from impinging on the positive electrode insulator 60P and the negative electrode insulator 60N to deeply get into and adheres to the insulators. Furthermore, the solidified molten portion 90 has a surface 90S which continues to the outer annular step surface 43U of the lid 40 and to the peripheral outward surface 82U of the stopper 80 to come closer to the lid thicknwise outside LTU (an upper side in FIG. 5) as forming a convex shape. Therefore, in this battery 1, there is no portion degraded its sealing performance due to local reduction in a volume of the molten metal constituting the solidified molten portion 90 which causes local reduction in a dimension of the solidified molten portion 90 in the lid thickwise direction LT. As mentioned above, the battery 1 achieves preferable insulation characteristics with restraining adhesion of the spatters to the positive electrode insulator 60P and the negative electrode insulator 60N and preferable sealing characteristics of welding the stopper 80 to the liquid inlet circumferential portion 42 of the lid 40.

As mentioned above, in the battery 1 of the present embodiment, the liquid inlet 40LH and the stopper 80 are provided in a portion of the lid 40 closer to the negative electrode terminal 50N than a center in the battery width direction BH (a lower right side in FIG. 1). Accordingly, as understood easily from FIG. 1, a negative electrode shortest distance LN as the shortest distance between the annular solidified molten portion 90 formed by welding the stopper 80 and the negative electrode insulator 60N is made smaller than a positive electrode shortest distance LP as the shortest distance between the solidified molten portion 90 and the positive electrode insulator 60P. In the battery 1 (the case 20) of the present embodiment, as the shorter one of the positive electrode shortest distance LP and the negative electrode shortest distance LN, the negative electrode shortest distance LN is set as about 25 mm which is shorter than 30 mm. When a distance from the solidified molten portion 90 to the insulators 60P and 60N is thus short, a flying distance of the spatters scattering from the solidified molten portion 90 is short, so that the spatters in the molten state are easy to adhere to the insulators 60P and 60N by impinging and deeply getting into the insulators. However, in the present embodiment, the solidified molten portion 90 is positioned over the entire circumference on the lid thickwise inside LTI (a lower side in FIG. 5) than the lid outer plane 40U of the lid 40. Accordingly, it is effectively prevented that the molten spatters flying at a low angle impinge on the negative electrode insulator 60N having the short negative electrode shortest distance LN, thereby maintaining the preferable insulation characteristics.

The electrode body 10 housed in the case 20 is a so-called flat-wound electrode body formed by winding a strip-shaped positive electrode plate 11 and a strip-shaped negative electrode plate 12 interposed with a pair of strip-shaped separators 13 and pressing them in the battery thickwise direction CH to be flattened. This electrode body 10 is placed sideways, namely, in a posture to arrange a winding axis 10X to coincide with the battery widthwise direction BH and housed in the case 20. A positive current collecting portion 10P conducting with the positive electrode plate 11 in the electrode body 10 is connected to the positive electrode terminal 50P, and as mentioned above, this positive electrode terminal 50P penetrates the lid 40 and extends outside. Further, a negative current collecting portion 10N conducting with the negative electrode plate 12 in the electrode body 10 is connected to the negative electrode terminal 50N, and this negative electrode terminal 50N penetrates the lid 40 and extends outside.

Next, a producing method of this battery 1 is explained with reference to a flowchart in FIG. 2 and enlarged sectional views of FIG. 3 to FIG. 5.

Firstly, in a to-be-sealed battery forming step S1, the flat-wound electrode body 10 has been formed in advance by a known method. Further, by use of a method such as ultrasonic welding, the positive current collecting portion 10P and the negative current collecting portion 10N of the electrode body 10 are each connected to each inner end portion of the positive electrode terminal 50P and the negative electrode terminal 50N which are fixedly provided in a to-be-sealed lid 40M so that the to-be-sealed lid 40M and the electrode body 10 are integrated by the positive electrode terminal 50P and the negative electrode terminal 50N. Furthermore, the electrode body 10 is covered with a resin film (not shown) which has been folded into a box-like shape.

Subsequently, in an electrode body housing step S11 in the to-be-sealed battery forming step S1, the electrode body 10 integrated with the to-be-sealed lid 40M is housed in the case body 30 through the opening 30H, and the opening 30H of the case body 30 is closed by the to-be-sealed lid 40M.

Subsequently, in a sealing step S12, by use of a method such as laser welding, the case body 30 and the to-be-sealed lid 40M are welded over an entire circumference of the to-be-sealed lid 40M to form the case 20.

In a subsequent injecting step S13, electrolytic solution 70 of a predetermined amount is injected in the case 20 through the liquid inlet 40LH of the to-be-sealed lid 40M. Thus, the electrolytic solution 70 is impregnated in the electrode body 10. Thus, a to-be-sealed battery 1M in which inside and outside of the case 20 are communicated through the liquid inlet 40LH is formed. Herein, prior to performing the following stopper arranging step S2 and a stopper welding step S3, this to-be-sealed battery 1M may be applied with processing such as initial charging and aging and applied with various tests.

In the stopper arranging step S2, as shown in FIG. 3, of the to-be-sealed lid 40M of the to-be-sealed battery 1M, a to-be-sealed stopper 80M is placed on the liquid inlet circumferential portion 42 to cover the liquid inlet 40LH by the to-be-sealed stopper 80M.

In the following stopper welding step S3, the liquid inlet circumferential portion 42 of the to-be-sealed lid 40M and an outer peripheral edge portion 82 of the to-be-sealed stopper 80M are laser welded over the entire circumference by laser beam LB. Thus, the to-be-sealed lid 40M and the to-be-sealed stopper 80M constitute the lid 40 to which the stopper 80 is welded. In between the liquid inlet circumferential portion 42 of this lid 40 and the outer peripheral edge portion 82 of the stopper 80, the solidified molten portion 90 formed by metal of those elements which have once got molten and then solidified is formed annularly, and thus the battery 1 in which the electrode body 10 is hermetically sealed in the case 20 is completed (see FIG. 5).

The completed hermetically-sealed battery 1 may be applied with various processes and tests prior to the following shipping.

Next, the to-be-sealed lid 40M and the to-be-sealed stopper 80M of the present embodiment used in the stopper arranging step S2 is explained (see FIG. 3).

Herein, in the to-be-sealed lid 40M and the lid 40, the lid thickwise direction LT, the lid thickwise outside LTU, and the lid thickwise inside LTI are indicated with arrows in FIG. 3. The lid thickwise direction LT coincides with the battery height direction AH in the battery 1. Further, a hole radial outside HDU and a hole radial inside HDI centered about a hole axis LHX of the liquid inlet 40LH are also indicated with arrows in FIG. 3. In the battery 1, the lid thickwise direction LT coincides with the battery height direction AH. These directions are similarly arranged in FIG. 4 to FIG. 9, too.

Furthermore, in the to-be-sealed stopper 80M and the stopper 80, the stopper thickwise direction PT, the stopper thickwise outside PTU, and the stopper thickwise inside PTI are also indicated with arrows in FIG. 3. In a state in which the to-be-sealed stopper 80M is placed on the liquid inlet circumferential portion 42 of the to-be-sealed lid 40M, these directions coincide with the lid thickwise direction LT, the lid thickwise outside LTU, and the lid thickwise inside LTI, respectively, as shown in FIG. 3. A stopper radial outside PDU and a stopper radial inside PDI centered about a stopper axis PX of the to-be-sealed stopper 80M and the stopper 80 are also indicated with arrows in FIG. 3. In a state in which the to-be-sealed stopper 80M is placed on the liquid inlet circumferential portion 42 of the to-be-sealed lid 40M such that the stopper axis PX coincides with the hole axis LHX, these directions coincide with the hole radial outside HDU and the hole radial inside HDI centered about the hole axis LHX as shown in FIG. 3. However, as shown in FIG. 4, if the to-be-sealed stopper 80M is misplaced from the liquid inlet circumferential portion 42 of the to-be-sealed lid 40M, the stopper axis PX may not coincide with the hole axis LHX. These directions are also similarly arranged in FIG. 4 to FIG. 9.

The to-be-sealed lid 40M is of a rectangular flat-plate-like shape formed of a plate-like lid outer plane 40U facing the lid thickwise outside LTU (an upper side in FIG. 3) and a plate-like lid inner plane 40I facing the lid thickwise inside LTI (a lower side in FIG. 3). The liquid inlet circumferential portion 42 of this to-be-sealed lid 40M includes a contact step portion 44 of an annular shape surrounding the liquid inlet 40LH and an outer step portion 43 of an annular shape surrounding this contact step portion 44.

To be more specific, the liquid inlet circumferential portion 42 includes the contact step portion 44 provided with an annular-flat-shaped lid contact surface 44U annularly surrounding the liquid inlet 40LH of a circular-hole shape penetrating through the to-be-sealed lid 40M in the lid thickwise direction LT and facing the lid thickwise outside LTU on the lid thickwise inside LTI than the lid outer plane 40U. In addition, the liquid inlet circumferential portion 42 further includes the outer step portion 43 of an annular shape surrounding the contact step portion 44, and the outer step portion 43 is provided with the annular-flat-shaped outer annular step surface 43U being positioned on the lid thickwise inside LTI than the lid outer plane 40U, on the lid thickwise outside LTU than the lid contact surface 44U, and on the hole radial outside HDU than the lid contact surface 44U and facing the lid thickwise outside LTU.

Furthermore, in the to-be-sealed lid 40M of the present embodiment, the outer step portion 43 is provided with a to-be-molten outer protruding portion 43P which is positioned on the hole radial inside HDI than the outer annular step surface 43U and continuously and annularly protrudes over an entire circumference on the lid thickwise outside LTU than the outer annular step surface 43U. This to-be-molten outer protruding portion 43P is a to-be-molten protruding portion which is to be molten in the stopper welding step S3. In the present embodiment, a protruding top face of the to-be-molten outer protruding portion 43P constitutes a flat outer protruding-portion top face 43PU. This outer protruding-portion top face 43PU has an inner peripheral edge 43PUF on the hole radial inside HDI, and an inner step surface 43ID is formed to extend from this inner peripheral edge 43PUF toward the lid thickwise inside LTI to reach the lid contact surface 44U of the contact step portion 44. This inner step surface 43ID is of a cylindrical shape and faces the hole radial inside HDI.

On the other hand, the to-be-sealed stopper 80M includes a center portion 81 recessed toward the stopper thickwise inside PTI (a lower side in FIG. 3) to be of a conical frustum shape and the outer peripheral edge portion 82 of a flat annular shape surrounding this center portion 81. The center portion 81 includes a center recessed surface 81R depressed toward the stopper thickwise outside PTU to be of the conical frustum shape and a center protruding surface 81P protruding toward the stopper thickwise inside PTI to be of the conical frustum shape. Further, the outer peripheral edge portion 82 includes a stopper contact surface 82I of a flat annular shape facing the lid thicwise inside LTI, a peripheral outward surface 82U of a flat annular shape facing the stopper thickwise outside PTU, and an extended peripheral outward surface 82UE extending from this peripheral outward surface 82U to the stopper radial outside PDU. Further, this extended peripheral outward surface 82UE has an outer peripheral edge 82UEF on the stopper radial outside PDU, and a stopper outer peripheral end face 82T is formed to extend from the outer peripheral edge 82UEF toward the stopper thickwise inside PTI to reach the stopper contact surface 82I. This stopper outer peripheral end face 82T is of a cylindrical shape and faces the stopper radial outside PDU.

In the stopper arranging step S2, the to-be-sealed stopper 80M is disposed on the liquid inlet circumferential portion 42 of the to-be-sealed lid 40M of the to-be-sealed battery 1M to cover the liquid inlet 40LH by this to-be-sealed stopper 80M. Specifically, the to-be-sealed stopper 80M separately prepared is placed on the hole radial inside HDI of the outer step portion 43 of the liquid inlet circumferential portion 42 of the to-be-sealed lid 40M. In this stopper arranging step S2, the stopper contact surface 82I of the outer peripheral edge portion 82 of the to-be-sealed stopper 80M opposes the lid contact surface 44U of the contact step portion 44 of the to-be-sealed lid 40M to be contacted therewith. Thus, the annular outer peripheral edge portion 82 of the to-be-sealed stopper 80M comes to contact with the contact step portion 44 of the to-be-sealed lid 40M.

In the following stopper welding step S3, laser beam LB is irradiated to melt the to-be-molten outer protruding portion 43P and a part on the lid thickwise inside LTI than the to-be-molten outer protruding portion 43P of the outer step portion 43 of the to-be-molten lid 40M. Along with this, a part of the outer peripheral edge portion 82 of the to-be-sealed stopper 80M on the stopper radial outside PDU (roughly a part of the extended peripheral outward surface 82UE on the stopper thickwise inside PTI) is molten to laser-weld the outer peripheral edge portion 82 of the stopper 80 to the outer step portion 43 of the lid 40 over the entire circumference. A filler material is not used for this laser welding, and the formed solidified molten portion 90 is made only of metal (aluminum) constituting the lid 40 and the stopper 80.

In the present embodiment, as mentioned above, the to-be-sealed lid 40M includes the to-be-molten outer protruding portion 43P, and the laser welding in the stopper welding step S3 is performed by melting the to-be-molten outer protruding portion 43P. Accordingly, molten metal which is a molten part of the to-be-molten outer protruding portion 43P can be used for formation of the solidified molten portion 90. In this manner, the solidified molten portion 90 can be easily formed over the entire circumference with the surface 90S which continues to the outer annular step surface 43U and the peripheral outward surface 82U and forms a convex shape toward the lid thickwise outside LTU. Therefore, this battery 1 includes no portion that has locally less molten metal constituting the solidified molten portion 90, which could result in local reduction in a dimension of the solidified molten portion 90 in the lid thickwise direction LT (in an upper and lower direction in FIG. 5), causing degradation in the sealing performance of that portion.

Further, the solidified molten portion 90 of the battery 1 (the lid 40 after sealing) is positioned on the lid thickwise inside LTI (a lower side in FIG. 4) than the lid outer plane 40U of the lid 40 over its entire circumference. In the present embodiment 1, the solidified molten portion 90 is positioned on the lid thickwise inside LTI by about 0.2 mm than the lid outer plane 40U over its entire circumference. Therefore, in laser welding, the molten spatters flying at a low angle from the solidified molten portion 90 impinge on the outer step surface 43UD between the lid outer plane 40U and the outer step portion 43, so that the spatters are restrained from adhering by impinging on and deeply getting into the positive electrode insulator 60P and the negative electrode insulator 60N.

Herein, in the stopper arranging step S2, the to-be-sealed stopper 80M is disposed by inserting on the hole radial inside HDI of the outer step portion 43 of the to-be-sealed battery 1M. At this time, for easy insertion of the to-be-sealed stopper 80M in the outer step portion 43, a diameter of the stopper outer circumferential end face 82T of a cylindrical shape of the to-be-sealed stopper 80M needs to be smaller than a diameter of the cylindrical inner step surface 43ID of the outer step portion 43. Accordingly, when the to-be-sealed stopper 80M is disposed in the outer step portion 43 of the to-be-sealed lid 40M as shown in FIG. 3, there is created a clearance SS between the outer step portion 43 and the outer peripheral edge portion 82 of the to-be-sealed stopper 80M, namely between the cylindrical inner step surface 43ID of the outer step portion 43 and the stopper outer circumferential end face 82T of the to-be-sealed stopper 80M.

Furthermore, the to-be-sealed stopper 80M cannot be always disposed inside the outer step portion 43 of the to-be-sealed lid 40M such that the hole axis LHX of the liquid inlet 40LH of the to-be-sealed lid 40M coincides with the stopper axis PX of the to-be-sealed stopper 80M as shown in FIG. 3. When the to-be-sealed stopper 80M leans over in the outer step portion 43 of the to-be-sealed stopper 40M, the stopper axis PX could be displaced from the hole axis LHX as shown in FIG. 4, for example. In that case, a size of the clearance SS does not become uniform in the circumferential direction of the liquid inlet 40LH. Herein, the clearance SS having the maximum size which could be obtained by such an uneven clearance between the cylindrical inner step surface 43ID and the stopper outer circumferential end face 82T is defined as the maximum clearance SSX.

In the present embodiment, a radial section as shown in FIG. 4 is depicted when the clearance SS becomes the maximum clearance SSX, and an imaginary line HL1 (indicated with a double-chained line) is assumed. This imaginary line HL1 links the inner peripheral edge 43UF of the outer annular step surface 43U of the to-be-sealed lid 40M and the outer peripheral edge 82UEF as an upper end of the stopper outer circumferential end face 82T of the to-be-sealed stopper 80M. Further, of the to-be-molten outer protruding portion 43P, a protruding region ARP on the lid thickwise outside LTU than the imaginary line HL1 is conceived. Furthermore, a maximum clearance region ARS is also assumed. This maximum clearance region ARS is located on the lid thickwise inside LTI than the imaginary line HL1 and surrounded by the inner step surface 43ID, the stopper outer circumferential end face 82T, and the lid contact surface 44U. In the present embodiment, a section of the to-be-molten outer protruding portion 43P is configured such that a protruding-portion sectional area SP1 of the protruding region ARP is made larger than a maximum clearance sectional area SS1 of the maximum clearance region ARS. Accordingly, even after the to-be-molten outer protruding portion 43P is molten to fill in the maximum clearance SSX with that molten metal (not shown), surplus molten metal remains, and the surface of the molten metal reaches the lid thickwise outside LTU than the imaginary line HL1. Moreover, in a portion having the clearance SS smaller than the maximum clearance SSX, further surplus molten metal remains. Consequently, in the present embodiment, the surface 90S of the solidified molten portion 90 is of a convex shape over the entire circumference, so that the battery 1 having no partially thin portions in the thickness of the solidified molten portion 90 can be assuredly produced.

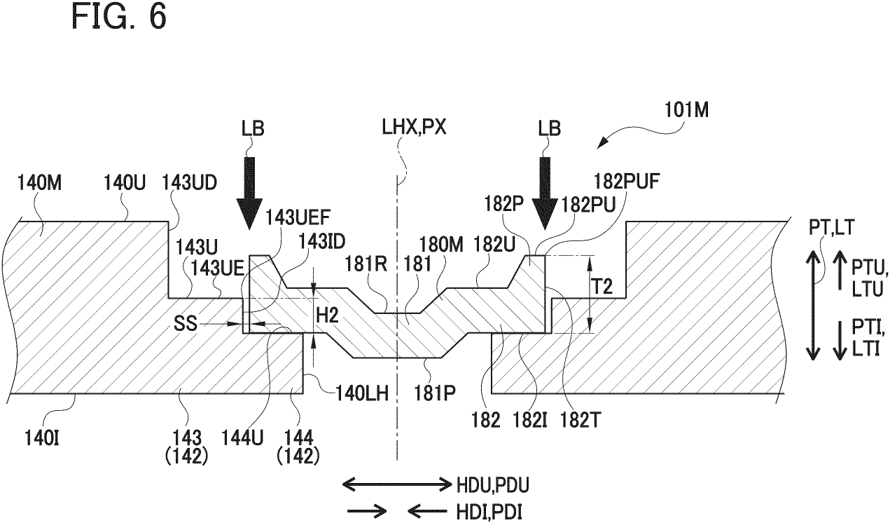

The to-be-sealed lid 40M of the present embodiment includes the to-be-molten outer protruding portion 43P on the hole radial inside HDI of the outer annular step surface 43U. On the other hand, the to-be-sealed stopper 80M has no to-be-molten outer circumferential protruding portion (for example, a portion corresponding to the to-be-molten stopper outer circumferential protruding portion 182P according to a modified embodiment (see FIG. 6) explained later) with the outer peripheral edge portion 82. The outer annular step surface 43U of the to-be-sealed lid 40M is positioned on the lid thickwise inside LTI (a lower side in FIG. 3) than the peripheral outward surface 82U of the to-be-sealed stopper 80M. Namely, a thickness of the outer step portion 43 is made thin so that the heat is hard to be conducted toward the hole radial outside HDU. In the stopper welding step S3, therefore, the heat of the irradiated laser beam LB is restrained from escaping through the outer step portion 43 toward the hole radial outside HDU than the liquid inlet circumferential portion 42, and thus the to-be-molten outer protruding portion 43P and others can be appropriately molten.

Further in the present embodiment, the to-be-molten outer protruding portion 43P of the to-be-sealed lid 40M is arranged such that a height H1 from the lid contact surface 44U to the outer protruding-portion top face 43PU of the to-be-molten outer protruding portion 43P (in the present embodiment, the height H1 = 0.5 mm) is made to be larger than the thickness T1 from the stopper contact surface 82I to the extended peripheral outward surface 82UE of the to-be-sealed stopper 80M (in the present embodiment, the thickness T1 = 0.4 mm). This height H1 is preferably set as 1.1 to 1.4 times long as the thickness T1, and set to be 1.25 times (H1 = 1.25 × T1) in the present embodiment.

In the stopper welding step S3, as shown in FIG. 5, melting is preferably made such that a leading end (an inner end on the lid thickwise inside LTI) 90A of the formed solidified molten portion 90 is positioned at the almost same level with the lid contact surface 44U in the lid thickwise direction LT. If the position of the leading end 90A is too shallow, the welding strength is lowered and if the position is too deep, the entire lid 40 could be molten in the lid thickwise direction LT, both of which are not preferable.

When the height H1 is too large as compared to the thickness T1, a difference is easily generated in the molten state between the outer step portion 43 having the to-be-molten outer protruding portion 43P of the lid 40 and the outer peripheral edge portion 82 of the stopper 80 by irradiation of the laser beam LB to the both from the lid thickwise outside LTU. Specifically, a vicinity of the stopper outer-peripheral end face 82T of the outer peripheral edge portion 82 of the stopper 80 is molten entirely in the lid thickwise direction LT, but a portion on the lid thickwise inside LTI than the to-be-molten outer protruding portion 43P of the outer step portion 43 of the lid 40 fails to be molten deeply enough. This causes distortion in a shape of the formed solidified molten portion 90, and thus the outer step portion 43 of the lid 40 and the outer peripheral edge portion 82 of the stopper 80 could be welded incompletely.

On the other hand, when the height H1 is not too large as compared to the thickness T1, an amount of molten metal formed of the to-be-molten outer protruding portion 43P of the outer step portion 43 becomes less, which could cause shortage in a filling amount of the molten metal to be filled in the clearance between the outer step portion 43 of the lid 40 and the outer peripheral edge portion 82 of the stopper 80.

To address this, in the present embodiment, the height H1 is arranged to be as 1.25 times long as the thickness T1 within a range of 1.1 to 1.4 times. Thus, by melting the to-be-molten outer protruding portion 43P, the molten metal (molten metal body) to become the solidified molten portion 90 is obtained, and the solidified molten portion 90 can be provided in a preferable shape between the outer step portion 43 of the lid 40 and the outer peripheral edge portion 82 of the stopper 80 to produce the battery 1 in which the outer step portion 43 and the outer peripheral edge portion 82 are welded.

### Modified Embodiment 1

The above-mentioned embodiment exemplifies the to-be-sealed lid 40M including the to-be-molten outer protruding portion 43P while the to-be sealed stopper 80M is not provided with a to-be-molten stopper outer circumferential protruding portion.

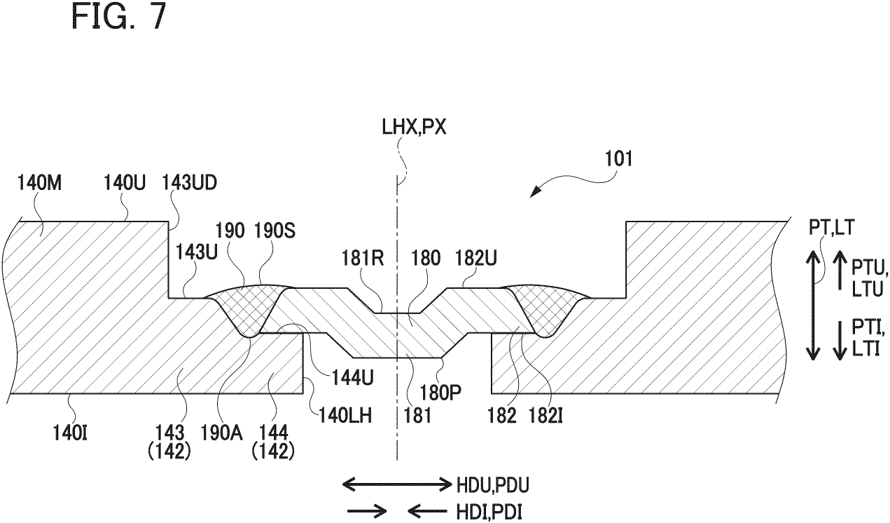

On the other hand, in the present modified embodiment (see FIGS. 6 and 7), while the to-be-sealed stopper 180M provided with a to-be-molten stopper outer circumferential protruding portion 182P in the outer peripheral edge portion 182 is used, the to-be-sealed lid 140M including no to-be-molten outer protruding portion is used.

In other words, the to-be-sealed lid 140M is also of a rectangular flat shape including a flat-plate-like lid outer plane 140U facing the lid thickwise outside LTU (an upper side in FIG. 6) and a flat-plate-like lid inner plane 140I facing the lid thickwise inside LTI (a lower side in FIG. 6). A liquid inlet circumferential portion 142 of this to-be-sealed lid 140M also includes an annular contact step portion 144 surrounding a liquid inlet 140LH and an annular outer step portion 143 surrounding this contact step portion 144.

To be more specific, the liquid inlet circumferential portion 142 is of an annular shape surrounding the circular-hole-shaped liquid inlet 140LH penetrating through the to-be-sealed lid 140M and includes the contact step portion 144. This contact step portion 144 includes an annular flat lid contact surface 144U which is positioned on the lid thickwise inside LTI than the lid outer plane 140U to face the lid thickwise outside LTU. Furthermore, the liquid inlet circumferential portion 142 is of an annular shape surrounding the contact step portion 144 and includes the outer step portion 143. This outer step portion 143 includes an annularly flat-shaped outer annular step surface 143U which is positioned on the hole radial outside HDU than the lid contact surface 144U on the lid thickwise inside LTI than the lid outer plane 140U and the lid thickwise outside LTU than the lid contact surface 144U to face the lid thickwise outside LTU.

The to-be-sealed lid 140M of the present modified embodiment 1 is however not provided with the to-be-molten outer protruding portion in this outer step portion 143, and instead the outer step portion 143 includes an extended outer annular step surface 143UE extending from the outer annular step surface 143U to the hole radial inside HDI. Further, the outer step portion 143 includes an inner step surface 143ID extending from the inner peripheral edge 143UEF of the extended outer annular step surface 143UE to the lid thickwise inside LTI to reach the lid contact surface 144U and to face the hole radial inside HDI.

On the other hand, the to-be-sealed stopper 180M also includes a center portion 181 recessed its center part toward the stopper thickwise inside PTI and an outer peripheral edge portion 182 of a flat annular shape surrounding the center portion 181. The outer peripheral edge portion 182 includes a stopper contact surface 182I of a flat annular shape facing the lid thickwise inside LTI, a peripheral outward surface 182U of a flat annular shape facing the stopper thickwise outside PTU, and a to-be-molten outer circumferential protruding portion 182P being positioned on the stopper radial outside PDU than the peripheral outward surface 182U and continuously and annularly protruding over the entire circumference on the stopper thickwise outside PTU than the peripheral outward surface 182U. In the present modified embodiment 1, a protruding-portion top face of the to-be-molten stopper outer circumferential protruding portion 182P constitutes a flat stopper protruding-portion top face 182PU. This stopper protruding-portion top face 182PU has the outer peripheral edge 182PUF on the stopper radial outside PDU, and an outer end face 82T is formed to extend from this outer peripheral edge 182PUF toward the stopper thickwise inside PTI to reach the stopper contact surface 182I. This outer end face 182T is of a cylindrical shape and faces the stopper radial outside PDU. This to-be-molten stopper outer circumferential protruding portion 182P constitutes the to-be-molten protruding portion to be molten in the stopper welding step S3.

In the stopper arranging step S2 in the present modified embodiment 1, as shown in FIG. 6, on the hole radial inside HDI of the outer step portion 143 of the liquid inlet circumferential portion 142 in the to-be-sealed lid 140M of the to-be-sealed battery 101M, a separately prepared to-be-sealed stopper 180M is disposed. In this stopper arranging step S2, the stopper contact surface 182I of the to-be-sealed stopper 180M opposes the lid contact surface 144U of the to-be-sealed lid 140M to be contacted therewith. Thus, the outer peripheral edge portion 182 of the to-be-sealed stopper 180M is in contact with the contact step portion 144 of the to-be-sealed lid 140M.

In the following stopper welding step S3, the laser beam LB is irradiated to melt the to-be-molten stopper outer circumferential protruding portion 182P of the outer peripheral edge portion 182 of the to-be-sealed stopper 180M. Further, a part of the outer peripheral edge portion 182 on the stopper thickwise inside PTI than the to-be-molten stopper outer circumferential protruding portion 182P is molten. Along with this, a part of the outer step portion 143 of the to-be-sealed lid 140M on the hole radial inside HDI (a portion roughly on the lid thickwise inside LTI of the extended outer annular step surface 143UE) is molten. Thereby, the outer peripheral edge portion 182 of the stopper 180 is laser-welded to the outer step portion 143 of the lid 140 over the entire circumference (see FIG. 7).

In this manner of the present modified embodiment 1, the to-be-sealed stopper 180M includes the to-be-molten stopper outer circumferential protruding portion 182P, and the laser welding in the stopper welding step S3 is performed by melting this to-be-molten stopper outer circumferential protruding portion 182P. Therefore, the molten metal by the amount of the to-be-molten stopper outer circumferential protruding portion 182P that has been molten can be used for formation of the solidified molten portion 190. As a result of this, the solidified molten portion 190 having the surface 190S of a convex shape continuing to the outer annular step surface 143U and the peripheral outward surface 182U and protruding toward the lid thickwise outside LTU can be easily formed over the entire circumference. Accordingly, this battery 101 also has no portion locally reduced the molten metal constituting the solidified molten portion 190 to locally reduce the dimension of the solidified molten portion in the lid thickwise direction LT (in the upper and lower direction in FIG. 7), which could result in degradation in the sealing performance.

Further, the solidified molten portion 190 of the battery 101 is positioned on the lid thickwise inside LTI (a lower side in FIG. 7) than the lid outer plane 140U of the lid 140 over its entire circumference. Therefore, in laser welding, the molten spatters flying at a low angle from the solidified molten portion 190 hit on the outer step surface 143UD, so that the spatters are restrained from adhering by hitting on and deeply getting into the positive electrode insulator 60P and the negative electrode insulator 60N.

In the present modified embodiment 1, a section of the to-be-molten stopper outer circumferential protruding portion 182P is configured such that even when the maximum clearance SSX is filled with the molten metal (not shown) of the to-be-molten stopper outer circumferential protruding portion 182P, the section is arranged such that surplus molten metal remains. Moreover, in a portion having the clearance SS smaller than the maximum clearance SSX, further surplus molten metal remains. Consequently, in the present modified embodiment 1, the surface 190S of the solidified molten portion 190 is of a convex shape over the entire circumference, so that the battery 101 having no partially thin portions in the thickness of the solidified molten portion 190 can be assuredly produced.

Further in the present modified embodiment 1, the to-be-molten stopper outer circumferential protruding portion 182P is arranged such that a thickness T2 from the stopper contact surface 182I to the stopper protruding portion top face 182PU of the to-be-molten stopper outer circumferential protruding portion 182P (in the present modified embodiment 1, the thickness T2 = 0.5 mm) is made to be larger than the height H2 from the lid contact surface 144U to the extended outer annular step surface 143UE (in the present embodiment, the height H2 = 0.4 mm). This thickness T2 is preferably set as 1.1 to 1.4 times long as the height H2 (T2 = 1.1 × H2 to 1.4 × H2), and set to be 1.25 times (H1 = 1.25 × H2) in the present modified embodiment 1.

In the stopper welding step S3, as shown in FIG. 7, the outer step portion 143 of the lid 140 and the outer peripheral edge portion 182 of the stopper 180 are preferably molten by the laser beam LB such that the leading end 190A of the formed solidified molten portion 190 is positioned almost at the same level with the lid contact surface 144U.

When the thickness T2 is too large as compared to the height H2, irradiation of the laser beam LB to the outer step portion 143 and the outer peripheral edge portion 182 from the lid thickwise outside LTU easily generates a difference in the molten state between the outer step portion 143 of the lid 40 and the outer peripheral edge portion 182 having the to-be-molten stopper outer circumferential protruding portion 182P of the stopper 180. Specifically, a vicinity of the inner step surface 143ID of the outer step portion 143 of the lid 140 is molten entirely in the lid thickwise direction LT, but a portion on the stopper thickwise inside PTI than the to-be-molten stopper outer circumferential protruding portion 182P of the outer peripheral edge portion 182 of the stopper 180 fails to be molten deeply enough. This causes distortion in a shape of the formed solidified molten portion 190, and thus the outer step portion 143 of the lid 140 and the outer peripheral edge portion 182 of the stopper 180 could be welded incompletely.

On the other hand, when the thickness T2 is not too large as compared to the height H2, an amount of molten metal formed of the molten outer peripheral edge portion 182 of the stopper 180 becomes less, which could cause shortage in a filling amount of the molten metal to be filled in the clearance between the outer step portion 143 of the lid 140 and the outer peripheral edge portion 182 of the stopper 180.

To address this, in the present modified embodiment 1, the thickness T2 is arranged to be as 1.25 times long as the height H2 within a range of 1.1 to 1.4 times. Thus, by melting the to-be-molten stopper outer circumferential protruding portion 182P, the molten metal (molten metal body) to become the solidified molten portion 190 is obtained, and the solidified molten portion 190 can be provided in a preferable shape between the outer step portion 143 of the lid 140 and the outer peripheral edge portion 182 of the stopper 180 to produce the battery 101 in which the outer step portion 143 and the outer peripheral edge portion 182 are welded.

### Modified Embodiment 2

The above-mentioned embodiment and the modified embodiment 1 are exemplified with an example of providing the to-be-molten protruding portion (the to-be-molten outer protruding portion 43P and the to-be-molten stopper outer circumferential protruding portion 182P) in only either one of the to-be-sealed lids 40M and 140M or the to-be-sealed stoppers 80M and 180M.

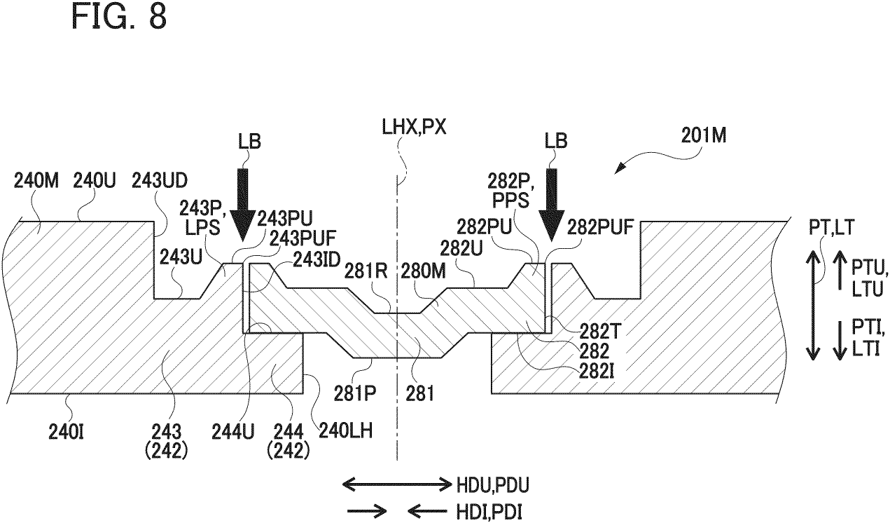

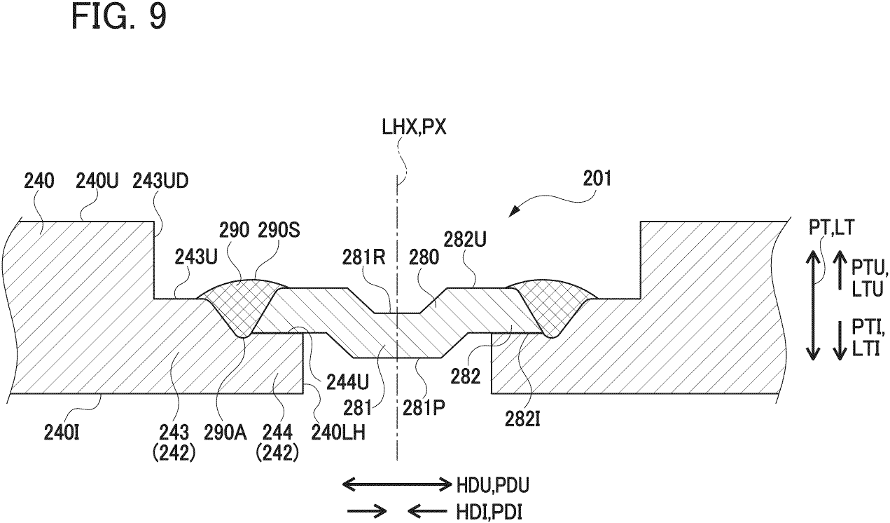

On the contrary, in the present modified embodiment 2 (see FIG. 8 and FIG. 9), a to-be-sealed lid 240M provided with a to-be-molten outer protruding portion 243P on an outer step portion 243 and a to-be-sealed stopper 280M provided with a to-be-molten outer circumferential protruding portion 282P on an outer peripheral edge portion 282 are used.

In other words, the to-be-sealed lid 240M is also of a rectangular flat plate-like shape formed of a plate-like lid outer plane 240U facing the lid thickwise outside LTU (an upper side in FIG. 8) and a plate-like lid inner plane 240I facing the lid thickwise inside LTI (a lower side in FIG. 8). A liquid inlet circumferential portion 242 of this to-be-sealed lid 240M also includes a contact step portion 244 of an annular shape surrounding a liquid inlet 240LH and an outer step portion 243 of an annular shape surrounding this contact step portion 244.

Among those components, the contact step portion 244 is provided with an annular-flat-shaped lid contact surface 244U annularly surrounding the liquid inlet 240LH penetrating through the to-be-sealed lid 240M and facing the lid thickwise outside LTU on the lid thickwise inside LTI than the lid outer plane 240U.

In addition, the outer step portion 243 is of an annular shape surrounding the contact step portion 244 and includes the annular-flat-shaped outer annular step surface 243U. This outer annular step surface 243U is positioned on the lid thickwise inside LTI than the lid outer plane 240U, on the lid thickwise outside LTU than the lid contact surface 244U, and on the hole radial outside HDU than the lid contact surface 244U and faces the lid thickwise outside LTU.

Furthermore, the outer step portion 243 is provided with a to-be-molten outer protruding portion 243P which is positioned on the hole radial inside HDI than the outer annular step surface 243U and continuously and annularly protrudes over an entire circumference on the lid thickwise outside LTU than the outer annular step surface 243U. A protruding top face of this to-be-molten outer protruding portion 243P constitutes a flat outer protruding-portion top face 243PU. This outer protruding-portion top face 243PU includes an inner peripheral edge 243PUF on the hole radial inside HDI. A cylindrical inner step surface 243ID is formed to extend from this inner peripheral edge 243PUF to the lid thickwise inside LTI to reach the lid contact surface 244U of the contact step portion 244 and faces the hole radial inside HDI.

On the other hand, the to-be-sealed stopper 280M includes a center portion 281 recessed its center part toward the stopper thickwise inside PTI and an annular outer peripheral edge portion 282 surrounding the center portion 281. The outer peripheral edge portion 282 includes a stopper contact surface 282I of a flat annular shape facing the lid thickwise inside LTI, a flat-annular peripheral outward surface 282U facing the stopper thickwise outside PTU, and a to-be-molten stopper outer circumferential protruding portion 282P being positioned on the stopper radial outside PDU than the peripheral outward surface 282U and continuously and annularly protruding to the stopper thickwise outside PTU than the peripheral outward surface 282U over the entire circumference. A protruding-portion top face of this to-be-molten stopper outer circumferential protruding portion 282P constitutes a flat stopper protruding-portion top face 282PU. This stopper protruding-portion top face 282PU includes the outer peripheral edge 282PUF on the stopper radial outside PDU. A cylindrical end face 282T is formed to extend from this outer peripheral edge 282PUF to the stopper thickwise inside PTI to reach the stopper contact surface 282I and faces the stopper radial outside PDU. In the present modified embodiment 2, both of the to-be-molten stopper outer circumferential protruding portion 282P of the to-be-sealed stopper 280M and the above-mentioned to-be-molten outer protruding portion 243P of the to-be-sealed lid 240M are the to-be-molten protruding portion which is to be molten in the stopper welding step S3.

In the stopper arranging step S2 of the present modified embodiment 2, as shown in FIG. 8, the to-be-sealed stopper 280M separately prepared is placed on the hole radial inside HDI of the outer step portion 243 of the liquid inlet circumferential portion 242 of the to-be-sealed lid 240M of a to-be-sealed battery 201M. In this stopper arranging step S2, the stopper contact surface 282I of the to-be-sealed stopper 280M opposes the lid contact surface 244U of the to-be-sealed lid 240M to be contacted therewith. Thus, the outer peripheral edge portion 282 of the to-be-sealed stopper 280M comes to contact with the contact step portion 244 of the to-be-sealed lid 240M.

In the following stopper welding step S3, the laser beam LB is irradiated to melt the to-be-sealed outer protruding portion 243P and a part of the outer step portion 243 of the to-be-sealed lid 240M on the lid thickwise inside LTI than the to-be-molten outer protruding portion 243P. Along with this, the to-be-molten stopper outer circumferential protruding portion 282P of the outer peripheral edge portion 282 of the to-be-sealed stopper 280M and a part of the outer peripheral edge portion 282 on the stopper thickwise inside PTI than the to-be-molten stopper outer circumferential protruding portion 282P are molten. In this manner, the outer peripheral edge portion 282 of the stopper 280 is laser welded to the outer step portion 243 of the lid 240 over its entire circumference (see FIG. 9).

In the present modified embodiment 2, as mentioned above, the to-be-sealed lid 240M includes the to-be-molten outer protruding portion 243P, the to-be-sealed stopper 280M includes the to-be-molten stopper outer circumferential protruding portion 282P, and the laser welding in the stopper welding step S3 is performed by melting the to-be-molten outer protruding portion 243P and the to-be-molten stopper outer circumferential protruding portion 282P. Accordingly, molten metal, which is a part of the to-be-molten outer protruding portion 243P and the to-be-molten stopper outer circumferential protruding portion 282P, can be used for formation of the solidified molten portion 290. In this manner, the solidified molten portion 290 can be easily formed over the entire circumference with the surface 290S which continues to the outer annular step surface 243U and the peripheral outward surface 282U and forms a convex shape toward the lid thickwise outside LTU. Therefore, this battery 201 also includes no portion that has locally less molten metal constituting the solidified molten portion 290, which could result in local reduction in a dimension of the solidified molten portion 290 in the lid thickwise direction LT (in an upper and lower direction in FIG. 9), which could cause degradation in the sealing performance of that portion.

Further, the solidified molten portion 290 of this battery 201 is also positioned on the lid thickwise inside LTI (a lower side in FIG. 9) than the lid outer plane 240U of the lid 240 over the entire circumference. Therefore, in laser welding, the molten spatters flying at a low angle from the solidified molten portion 290 hit on the outer step surface 243UD, so that the spatters are restrained from adhering by hitting on and deeply getting into the positive electrode insulator 60P and the negative electrode insulator 60N.

In the present modified embodiment 2, both the to-be-molten protruding portions of the to-be-molten outer protruding portion 243P and the to-be-molten stopper outer circumferential protruding portion 282P are molten to obtain the molten metal (molten metal body) as the solidified molten portion 290. Accordingly, even if the size of the clearance SS between the outer peripheral edge portion 282 of the stopper 280 and outer step portion 243 of the liquid inlet circumferential portion 242 of the lid 240 varies in the circumferential direction, a thickness of the solidified molten portion 290 can be assuredly obtained, and thus the battery 201 in which the outer peripheral edge portion 282 and the outer step portion 243 are preferably welded can be produced.

Further, in the present modified embodiment 2, too, a section of the to-be-molten outer protruding portion 243P and the to-be-molten stopper outer circumferential protruding portion 282P is configured such that even when the maximum clearance SSX is filled with the molten metal (not shown) as a molten those components, surplus molten metal is set to remain, though the detailed explanation thereof is omitted. Moreover, in a portion having the clearance SS smaller than the maximum clearance SSX, further surplus molten metal remains. Consequently, also in the present modified embodiment 2, the surface 290S of the solidified molten portion 290 is of a convex shape over the entire circumference, so that the battery 201 having no partially thin portions in the thickness of the solidified molten portion 290 can be assuredly produced.

As mentioned above, the present disclosure has been explained with the present embodiment and the modified embodiments 1 and 2, but the present disclosure is not limited to the embodiments and may naturally be applied with any appropriate modifications without departing from the scope of the disclosure. For example, in the embodiments, the electrode body 10 is exemplified with a flat-wound electrode body formed by winding the strip-shaped positive electrode plate 11 and others. Alternatively, as the electrode body 10, a laminated electrode body, which is formed by alternately laminating a plurality of cut-sheet shaped positive electrode sheet of a rectangular shape or the like and a plurality of cut-sheet shaped negative electrode sheets of a rectangular shape or the like interposed with separators therebetween, may be used.

Further, the embodiments are exemplified with the configuration that the outer annular step surface 43U of the lid 40 is positioned on the lid thickwise inside LTI (a lower side in FIG. 3 and FIG. 5) with respect to the peripheral outward surface 82U of the stopper 80. Alternatively, the outer annular step surface 43U of the lid 40 may be positioned on the lid thickwise outside LTU or at an almost same position in the lid thickwise direction LT with respect to the peripheral outward surface 82U of the stopper 80. However, as explained in the embodiments, positioning the outer annular step surface 43U of the lid 40 on the lid thickwise inside LTI (the lower side in FIG. 3 and FIG. 5) with respect to the peripheral outward surface 82U of the stopper 80 makes it possible to restrain the heat of the laser welding from escaping toward the hole radial outside HDU than the liquid inlet circumferential portion 42 and to assuredly melt the to-be-molten protruding portion.

Further, the lid 40 is explained with a configuration in which the hole radial inside HDI of the contact step portion 44 is constituted as the liquid inlet 40LH. Alternatively, as indicated with a broken line in FIG. 3 and FIG. 5, the lid may be configured with a step portion 45 on the hole radial inside HDI of the contact step portion 44 protruding toward the hole radial inside HDI. Further, in the embodiments, the lid 40 is configured such that the hole radial outside HDU than the outer step portion 43 continues to the lid outer plane 40U. Alternatively, as indicated with another broken line in FIG. 3 and FIG. 5, the lid 40 may further be formed with a groove 46 of an annular recessed shape recessed on the lid thickwise inside LTI than the lid outer plane 40U with a clearance from the outer step portion 43 on the hole radial outside HDU of the outer step portion 43.

Reference Signs List

| | |
|---|---|
| 1, 101, 201 | Battery (Power storage device) |
| 1M, 101M, 201M | To-be-sealed battery |
| 10 | Electrode body |
| 30 | Case body member |
| 30H | Opening (of the case body) |
| 40, 140, 240 | Lid |
| 40M, 140M, 240M | To-be-sealed lid |
| LT | Lid thickwise direction |
| LTI | Lid thickwise inside |
| LTU | Lid thickwise outside |
| 40U, 140U, 240U | Lid outer plane |
| 40LH, 140LH, 240LH | Liquid inlet |
| LHX | Hole axis (of the liquid inlet) |
| 42, 142, 242 | Liquid inlet circumferential portion |
| HDI | Hole radial inside |
| HDU | Hole radial outside |
| 43, 143, 243 | Outer step portion |
| 43U, 143U, 243U | Outer annular step surface |
| 43UF, 243UF surface) | Inner peripheral edge (of the outer annular step |
| 143UE, 243UE | Extended outer annular step surface |
| 143UEF, 243UEF step surface) | Inner peripheral edge (of the extended outer annular |
| H2 outer annular step surface) | Height (from the lid contact surface to the extended |
| 43P, 243P protruding portion) | To-be-molten outer protruding portion (to-be-molten |
| 43PU, 243PU top face) | Outer protruding-portion top face (protruding-portion |
| 43PUF, 243PUF top face) | Inner peripheral edge (of the outer protruding-portion |
| H1 protruding-portion top face) | Height (from the lid contact surface to the outer |
| 43ID, 143ID, 243ID the contact step portion) | Inner step surface (of the outer step portion reaching |
| 43UD, 143UD, 243UD the lid outer plane) | Outer step surface (of the outer step portion reaching |
| 44, 144, 244 | Contact step portion |
| 44U, 144U, 244U | Lid contact surface |
| 60P | Positive electrode insulator |
| 60N | Negative electrode insulator |
| LP | Positive electrode shortest distance |
| LN | Negative electrode shortest distance |
| 80, 180, 280 | Stopper |
| 80M, 180M, 280M | To-be-sealed stopper |
| PX | Stopper axis (of the stopper) |
| PTI | Stopper thickwise inside |
| PTU | Stopper thickwise outside |
| PDI | Stopper radial inside |
| PDU | Stopper radial outside |
| T1 | Thickness (from the stopper contact surface to the |
| extended peripheral outward surface) ) | |
| 82, 182, 282 | Outer peripheral edge |
| 82I, 182I, 282I | Stopper contact surface (of the outer peripheral edge |
| portion) | |
| 82U, 182U, 282U | Peripheral outward surface (of the outer peripheral |
| edge portion) | |
| 82UE | Extended peripheral outward surface |
| 82UEF | Outer peripheral edge (of the extended peripheral |
| outward surface) | |
| 82T | Stopper outer-peripheral end face (of the outer |
| peripheral edge portion) | |
| 182P, 282P | To-be-molten stopper outer circumferential protruding |
| portion (to-be-molten protruding | portion) |
| 182PU, 282PU | Stopper protruding-portion top face (protruding- |
| portion top face) | |
| 182PUF, 282PUF | Inner peripheral edge (of the stopper protruding- |
| portion top face) | |
| T2 | Thickness (form the stopper contact surface to the |
| stopper protruding-portion top face) | |
| SS | Clearance (between the outer peripheral edge portion |
| of the stopper before welding and the outer step portion of the lid) | |
| SSX | Maximum clearance |
| HL1 | Imaginary line |
| ARP | Protruding region |
| SP1 | Protruding portion sectional area |
| ARS | Maximum clearance region |
| SS1 | Maximum clearance sectional area |
| 90, 190, 290 | Solidified molten portion |
| 90S, 190S, 290S | Surface (of the solidified molten portion) |
| 90A, 190A, 290A | Leading end (on the lid thickwise inside of the |
| solidified molten portion) | |
| S2 | Stopper arranging step |
| LB | Laser beam (energy beam) |
| S3 | Stopper welding step |

What is claimed is:

1. A power storage device comprising:
an electrode body;
a case body having an opening and housing the electrode body therein;
a lid of a flat-plate-like shape sealing the opening and having a liquid inlet penetrating therethrough in a lid thickwise direction;
a positive electrode terminal and a negative electrode terminal conducting with the electrode body and penetrating through the lid to extend outside;
a positive electrode insulator insulating the lid and the positive electrode terminal;
a negative electrode insulator insulating the lid and the negative electrode terminal; and
a stopper welded by energy beam to a liquid inlet circumferential portion surrounding the liquid inlet of the lid to seal the liquid inlet, wherein
the liquid inlet circumferential portion of the lid includes:
a contact step portion of an annular shape including a lid contact surface of an annular shape and surrounding the liquid inlet; and
an outer step portion of an annular shape including an outer annular step surface of an annular flat shape and surrounding the contact step portion,
the lid contact surface is configured to
be positioned on a lid thickwise inside than a lid outer plane of the lid and face toward a lid thickwise outside,
the outer annular step surface is configured to
be positioned on a hole radial outside than the lid contact surface, on the lid thickwise inside than the lid outer plane and on the lid thickwise outside than the lid contact surface, and face toward the lid thickwise outside,
the stopper is configured to:
be positioned on a hole radial inside than the outer step portion; include
a stopper contact surface of an annular shape facing toward the lid thickwise inside to oppose and be contacted with the lid contact surface, and
a peripheral outward surface of a flat shape facing toward the lid thickwise outside,
have an outer peripheral edge portion of an annular shape contacted with the contact step portion,
a solidified molten portion of an annular shape made of metal, which is once molten and then solidified,
is formed between the outer step portion of the lid and the outer peripheral edge portion of the stopper,
the solidified molten portion is configured to be positioned its entire circumference on the lid thickwise inside than the lid outer plane of the lid,
a surface of the solidified molten portion in its entire circumference is configured to:
continue to the outer annular step surface and the peripheral outward surface; and
form a convex shape toward the lid thickwise outside.

2. The power storage device according to claim 1, wherein, a shorter one of a positive electrode shortest distance between the positive electrode insulator and the solidified molten portion and a negative electrode shortest distance between the negative electrode insulator and the solidified molten portion is equal to or less than 30 mm.

3. A producing method of a power storage device comprising:
an electrode body;
a case body having an opening and housing the electrode body therein;
a lid of a flat-plate-like shape sealing the opening and having a liquid inlet penetrating therethrough in a lid thickwise direction;
a positive electrode terminal and a negative electrode terminal conducting with the electrode body and penetrating through the lid to extend outside;
a positive electrode insulator insulating the lid and the positive electrode terminal;
a negative electrode insulator insulating the lid and the negative electrode terminal; and
a stopper welded by energy beam to a liquid inlet circumferential portion surrounding the liquid inlet of the lid to seal the liquid inlet, wherein
the liquid inlet circumferential portion of the lid includes:
a contact step portion of an annular shape including a lid contact surface of an annular shape and surrounding the liquid inlet; and
an outer step portion of an annular shape including an outer annular step surface of an annular flat shape and surrounding the contact step portion,
the lid contact surface is configured to
be positioned on a lid thickwise inside than a lid outer plane of the lid and face toward a lid thickwise outside,
the outer annular step surface is configured to
be positioned on a hole radial outside than the lid contact surface, on the lid thickwise inside than the lid outer plane and on the lid thickwise outside than the lid contact surface, and face toward the lid thickwise outside,
the stopper is configured to:
be positioned on a hole radial inside than the outer step portion; include
a stopper contact surface of an annular shape facing toward the lid thickwise inside to oppose and be contacted with the lid contact surface, and
a peripheral outward surface of a flat shape facing toward the lid thickwise outside,
have an outer peripheral edge portion of an annular shape contacted with the contact step portion,
a solidified molten portion of an annular shape made of metal, which is once molten and then solidified,
is formed between the outer step portion of the lid and the outer peripheral edge portion of the stopper,
the solidified molten portion is configured to be positioned its entire circumference on the lid thickwise inside than the lid outer plane of the lid,
a surface of the solidified molten portion in its entire circumference is configured to:
continue to the outer annular step surface and the peripheral outward surface; and
form a convex shape toward the lid thickwise outside, wherein
the outer step portion of the lid before welding and the outer peripheral edge portion of the stopper before welding include a to-be-molten protruding portion as at least any one of:
a to-be-molten outer protruding portion positioned on the hole radial inside than the outer annular step surface of the lid and protruding on the lid thickwise outside than the outer annular step surface; and
a to-be-molten stopper outer circumferential protruding portion positioned on the stopper radial outside than the peripheral outward surface of the stopper and protruding on the stopper thickwise outside than the peripheral outward surface,
the method includes:
stopper arranging to arrange the stopper on the hole radial inside than the outer step portion of the lid in a state in which the stopper contact surface of the stopper opposes and comes to contact with the lid contact surface of the lid; and
stopper welding to weld the outer step portion of the lid and the outer peripheral edge portion of the stopper over an entire circumference by energy beam, and
the stopper welding is to perform welding by melting the to-be-molten protruding portion.

4. The producing method of the power storage device according to claim 3, wherein
the to-be-molten protruding portion is of an annular shape over its circumference, and
the to-be-molten protruding portion includes a sectional shape large enough to remain surplus molten metal even when a clearance between the outer peripheral edge portion of the stopper before welding and the outer step portion of the lid before welding becomes the maximum clearance, which is the largest clearance formed therebetween, is filled with the molten metal of the to-be-molten protruding portion.

5. The producing method of the power storage device according to claim 3, wherein
the lid before welding includes the to-be-molten outer protruding portion on the hole radial inside of the outer annular step surface,
the stopper before welding includes no to-be-molten stopper outer circumferential protruding portion on the outer peripheral edge portion, and
the outer annular step surface of the lid is positioned on the lid thickwise inside than the peripheral outward surface of the stopper.

6. The producing method of the power storage device according to claim 3, wherein
the lid before welding includes the to-be-molten outer protruding portion on the hole radial inside of the outer annular step surface,
the stoper before welding includes no to-be-molten stopper outer circumferential protruding portion on the outer peripheral edge portion but includes an extended peripheral outward surface extending to the stopper radial outside from the peripheral outward surface and a stopper outer circumferential end face extending to the stopper thickwise inside from an outer peripheral edge of the extended peripheral outward surface and facing the stopper radial outside, and
a height from the lid contact surface to an outer protruding portion top face of the to-be-molten outer protruding portion is as 1.1 to 1.4 times large as a thickness from the stopper contact face to the extended peripheral outward surface of the stopper.

7. The producing method of the power storage device according to claim 3, wherein
the stopper before welding includes the to-be-molten stopper outer circumferential protruding portion on the outer peripheral edge portion,
the lid before welding includes no to-be-molten outer protruding portion on the hole radial inside of the outer annular step surface but includes an extended outer annular step surface extending to the hole radial inside from the outer annular step surface and an inner step surface extending to the lid thickwise inside from an inner peripheral edge of the extended outer annular step surface to reach the lid contact surface and facing the hole radial inside, and
a thickness from the stopper contact surface to a stopper protruding-portion top face of the to-be-molten stopper outer circumferential protruding portion is as 1.1 to 1.4 times large as a height from the lid contact face to the extended outer annular step surface.

8. The producing method of the power storage device according to claim 3, wherein
the lid before welding includes the to-be-molten outer protruding portion on the hole radial inside of the outer annular step surface, and
the stopper before welding includes the to-be-molten stopper outer circumferential protruding portion on the outer peripheral edge portion.

9. The producing method of the power storage device according to claim 4, wherein the lid before welding includes the to-be-molten outer protruding portion on the hole radial inside of the outer annular step surface,
the stopper before welding includes no to-be-molten stopper outer circumferential protruding portion on the outer peripheral edge portion, and
the outer annular step surface of the lid is positioned on the lid thickwise inside than the peripheral outward surface of the stopper.

10. The producing method of the power storage device according to claim 4, wherein the lid before welding includes the to-be-molten outer protruding portion on the hole radial inside of the outer annular step surface,
the stoper before welding includes no to-be-molten stopper outer circumferential protruding portion on the outer peripheral edge portion but includes an extended peripheral outward surface extending to the stopper radial outside from the peripheral outward surface and a stopper outer circumferential end face extending to the stopper thickwise inside from an outer peripheral edge of the extended peripheral outward surface and facing the stopper radial outside, and
a height from the lid contact surface to an outer protruding portion top face of the to-be-molten outer protruding portion is as 1.1 to 1.4 times large as a thickness from the stopper contact face to the extended peripheral outward surface of the stopper.

11. The producing method of the power storage device according to claim 5, wherein the lid before welding includes the to-be-molten outer protruding portion on the hole radial inside of the outer annular step surface,
the stoper before welding includes no to-be-molten stopper outer circumferential protruding portion on the outer peripheral edge portion but includes an extended peripheral outward surface extending to the stopper radial outside from the peripheral outward surface and a stopper outer circumferential end face extending to the stopper thickwise inside from an outer peripheral edge of the extended peripheral outward surface and facing the stopper radial outside, and
a height from the lid contact surface to an outer protruding portion top face of the to-be-molten outer protruding portion is as 1.1 to 1.4 times large as a thickness from the stopper contact face to the extended peripheral outward surface of the stopper.

12. The producing method of the power storage device according to claim 9, wherein the lid before welding includes the to-be-molten outer protruding portion on the hole radial inside of the outer annular step surface,
the stoper before welding includes no to-be-molten stopper outer circumferential protruding portion on the outer peripheral edge portion but includes an extended peripheral outward surface extending to the stopper radial outside from the peripheral outward surface and a stopper outer circumferential end face extending to the stopper thickwise inside from an outer peripheral edge of the extended peripheral outward surface and facing the stopper radial outside, and
a height from the lid contact surface to an outer protruding portion top face of the to-be-molten outer protruding portion is as 1.1 to 1.4 times large as a thickness from the stopper contact face to the extended peripheral outward surface of the stopper.

13. The producing method of the power storage device according to claim 4, wherein the stopper before welding includes the to-be-molten stopper outer circumferential protruding portion on the outer peripheral edge portion,
the lid before welding includes no to-be-molten outer protruding portion on the hole radial inside of the outer annular step surface but includes an extended outer annular step surface extending to the hole radial inside from the outer annular step surface and an inner step surface extending to the lid thickwise inside from an inner peripheral edge of the extended outer annular step surface to reach the lid contact surface and facing the hole radial inside, and
a thickness from the stopper contact surface to a stopper protruding-portion top face of the to-be-molten stopper outer circumferential protruding portion is as 1.1 to 1.4 times large as a height from the lid contact face to the extended outer annular step surface.

14. The producing method of the power storage device according to claim 4, wherein the lid before welding includes the to-be-molten outer protruding portion on the hole radial inside of the outer annular step surface, and
the stopper before welding includes the to-be-molten stopper outer circumferential protruding portion on the outer peripheral edge portion.
